(19) United States
(12) Patent Application Publication
(10) Pub. No.: US 2022/0381084 A1
(43) Pub. Date: Dec. 1, 2022

(54) LINE AND METHOD FOR PRODUCING SLATS FOR ROLLER SHUTTERS

(71) Applicant: DALLAN S.P.A., Castelfranco Veneto (Treviso) (IT)

(72) Inventor: Andrea DALLAN, Castelfranco Veneto (Treviso) (IT)

(21) Appl. No.: 17/826,363

(22) Filed: May 27, 2022

(30) Foreign Application Priority Data
May 31, 2021 (IT) 102021000014165

(51) Int. Cl. E06B 9/15

(52) U.S. Cl. CPC E06B 9/15; E06B 2009/17092

(57) ABSTRACT

The present invention relates to a production line of slats for roller shutters, comprising: a profiling machine; and a foaming machine, integrated in the profiling machine and suitable for dosing a predefined amount of a mixture of polyol and isocyanate in the unit of time inside a hollow, box section profile, partially open while it is being formed by means of an injection nozzle positionable in a predefined dispensing position along said longitudinal direction of advancement. The line comprises an optical acquisition device suitable for capturing images of the jet of the polyol and isocyanate mixture dispensed from said injection nozzle. The line comprises a control system that verifies whether the captured images of the jet are comparable within predefined error margins with said reference image or whether they deviate from it and activates an alarm procedure if a deviation from said reference image is detected.

### CROSS-REFERENCE TO RELATED APPLICATION

This application claims priority to Italian Patent Application No. 102021000014165 filed on May 31, 2021, the entire contents of which is hereby incorporated in its entirety by reference

### FIELD OF INVENTION

The subject of the present invention is a line and method for producing slats for roller shutters.

### BACKGROUND OF THE INVENTION

As is known, roller shutters consist of a plurality of elongated profiles, referred to as “slats” in jargon, connected in a modular manner to each other longitudinally to form a jointed curtain.

Generally, as illustrated in FIG. 1, each slat consists of a hollow, box section body C, made of metal and filled internally with polyurethane foam S (expanded polyurethane) to increase the structural strength of the slat, as well as its thermal insulation capacity.

Typically, the metal, box section body of a slat is obtained by bending and profiling a strip of metal sheet. During the profiling process, when the box section body is partially open with the inner cavity still accessible, it is foamed by injecting foam through the opening of the box section body. After foaming, the profile is cut to obtain foamed bars, which will then undergo machining (e.g. punching) to obtain the finished slats.

The polyurethane foaming process provides for the reagents (isocyanate and polyol) to be mixed together substantially only at the time of injection into the slat. The reagents are mixed in a mixing chamber associated with the injection nozzle so that polyurethane foam is formed substantially only within the slat. From the moment of foaming to the moment of cutting the foamed profile, at least thirty seconds must pass, which is the average time necessary for the mixture of the reagents to polymerize, generating polyurethane foam (expanded polyurethane). For this purpose, in a production line for producing slats for shutters, between the foaming station and the cutting station, there is a polymerization bench, i.e., a section of the line where the foamed profile is allowed to slide without external intervention to allow the polyurethane foam to polymerize. The length of the polymerization bench is determined according to the working speed of the production line.

In general, production lines for producing metal slats for roller shutters comprise sequentially the following apparatuses:
a metal sheet decoiler;
a metal sheet preheating bench (optional);
a profiling machine;
a foaming apparatus, integrated into the profiling machine;
a polymerization bench;
a closed foamed profile cutting apparatus for obtaining semi-finished slats;
at least one machining apparatus (typically, a punching machine) for finishing the slats, connected to the cutting station via a device for collecting and transporting the semi-finished slats; and
a bench for unloading the finished slats.

Foaming the box body being formed is one of the most delicate steps in the shutter slat production process. In particular, it is essential for the polyurethane foam dispensed by the injection nozzle to enter completely into the slot formed by the partially open box body, without escaping therefrom. In fact, if the polyurethane foam should leak even in part from the box body, it would create considerable problems of soiling, not only the slat being formed, but also the production line, starting with the rollers of the profiling machine.

In the event of a polyurethane foam leak, the system must be shut down as quickly as possible to prevent the polyurethane foam from being dragged a long way downstream of the foaming machine, increasing the soiled area. Due to the rapidity of solidification of polyurethane foam and the difficulties involved in its removal (in some cases even partial disassembly of the line may be necessary), a leakage of polyurethane foam may cause machine downtime of up to half a day. This is at the expense of the continuity of the production process.

Another operational requirement of the foaming stage is to ensure a constant flow of polyurethane foam for several hours. In fact, foaming takes place continuously on the box section body being formed, obtained from a reel of pre-painted sheet that may have a linear extension of several thousand meters. To ensure adequate continuity of production, the constancy in foaming must be ensured at least long enough to exhaust a roll of metal sheet.

Up to now, the control of foaming has been left to the production line workers. By necessity, this type of control may not be continuous. Therefore, it may happen that malfunctions in the foaming machine are not detected in time, causing uncontrolled leakage of polyurethane foam and inevitable long stops in the production line, which are necessary for cleaning and restoration operations.

In the sector of reference, there is therefore a still completely unsatisfied need to ensure control of the foaming stage that allows for not only the frequency of polyurethane foam leakages to be reduced, but also for the extent of these leakages to be reduced, having as the final objective the reduction of plant downtime linked to cleaning operations.

### SUMMARY OF THE INVENTION

Thus, it is a principal object of the present invention to eliminate totally or st least partially the drawbacks of the aforementioned prior art by providing a production line and a method for producing slats for roller shutters that allows the frequency and extent of polyurethane foam leaks to be significantly reduced, thereby limiting downtime associated with cleaning operations.

A further object of the present invention is to provide a production line and method for producing slats for roller shutters that are operationally simple to control and at the same time reliable.

### BRIEF DESCRIPTION OF THE DRAWINGS

The technical characteristics of the invention, according to the aforesaid objects, may be clearly seen in the content of the claims provided below, and its advantages will become more readily apparent in the detailed description that follows, made with reference to the appended drawings, which represent one or more purely illustrative and non-limiting embodiments thereof, wherein:

FIG. 1 is an orthogonal cross-sectional view of a traditional slat for roller shutters;

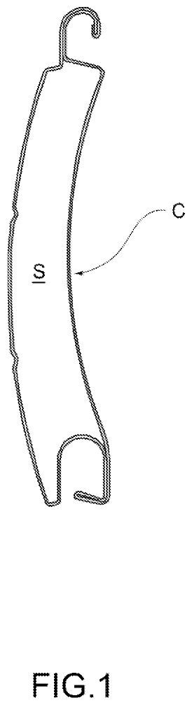

FIG. 2a is an orthogonal plan view of the lay-out of a shutter slat production line according to a preferred embodiment of the invention;

FIG. 2b is a detail view of a portion of the line of FIG. 2a;

FIG. 3 is a simplified cross-sectional view of the line of FIG. 2b according to the cross-sectional plane indicated therein and conducted at a foaming machine;

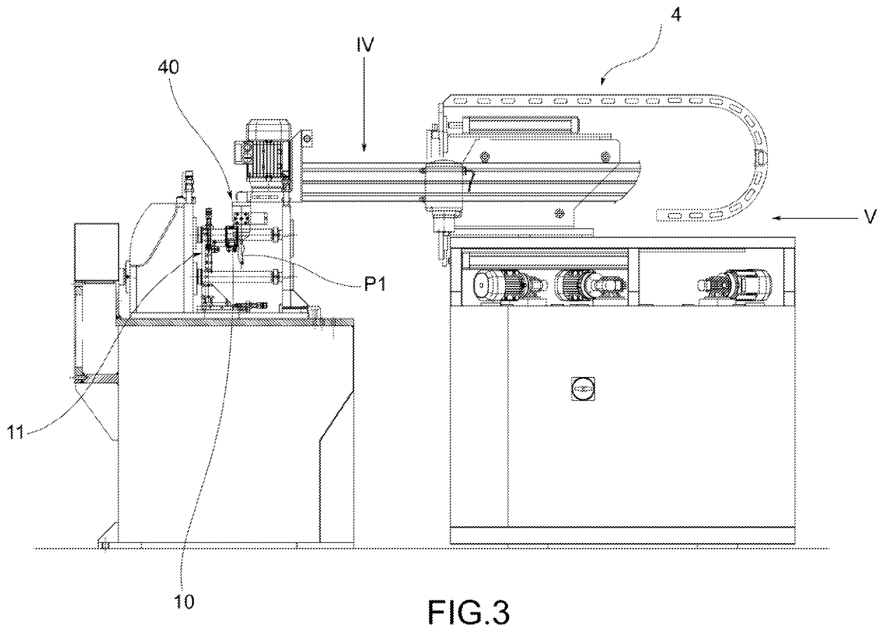

FIG. 4 is a simplified orthogonal view from above of the line portion with the foaming machine of FIG. 3, according to the arrow IV indicated therein;

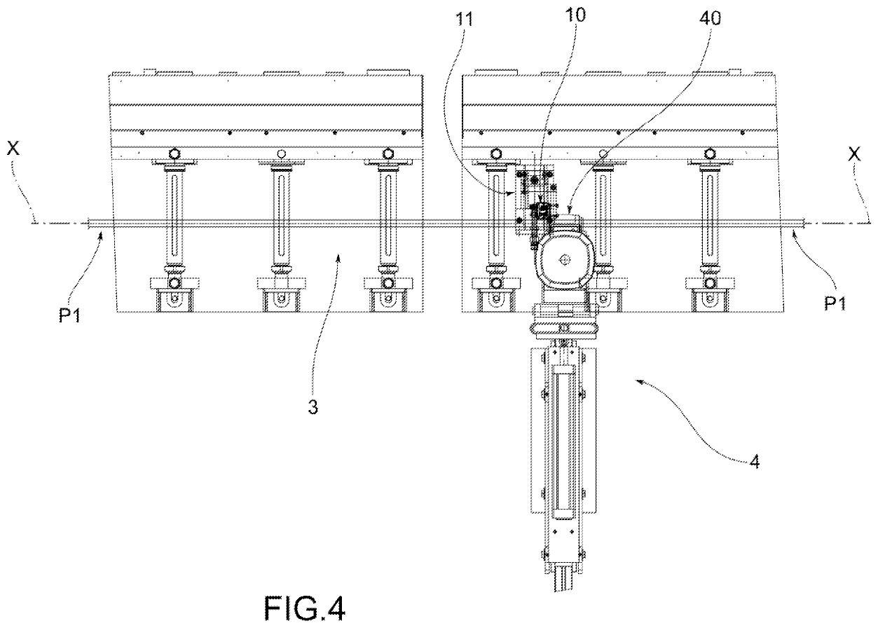

FIG. 5 is a simplified orthogonal view in elevation of the line portion with the foaming machine of FIG. 3, according to the arrow V indicated therein, with some parts removed to better illustrate others;

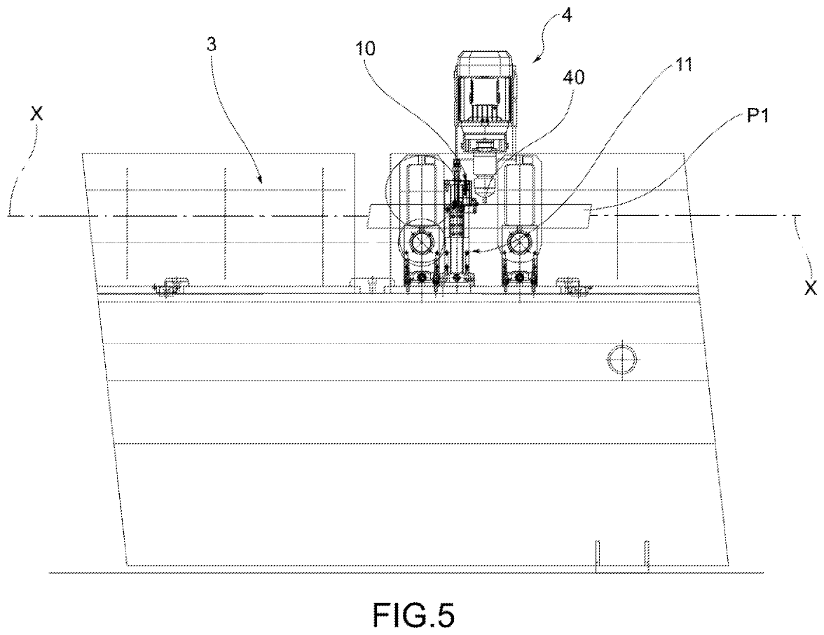

FIG. 6 is an enlarged view of a detail of FIG. 3;

FIG. 7 is an enlarged view of a detail of FIG. 5;

FIG. 8 is an enlarged view of a detail of FIG. 4;

FIG. 9 shows the detail of FIG. 8 further enlarged, illustrated with an optical acquisition device arranged in a different position with respect to the injection nozzle of the foaming machine;

FIG. 10 shows the detail of FIG. 7, illustrated with an optical acquisition device arranged in a different position with respect to the injection nozzle of the foaming machine; and

FIG. 11 shows a detail of FIG. 6 further enlarged, related to an optical acquisition device and the injection nozzle of the foaming machine.

### DETAILED DESCRIPTION

A production line for producing slats for roller shutters according to the invention has been denoted as a whole with the reference number 1 in the appended figures.

Here and in the rest of the description and in the claims, reference will be made to the line 1 in the condition of use. Therefore, any references to a lower or upper position or to a horizontal or vertical orientation should be interpreted in this sense.

According to a general embodiment of the invention, the production line 1 for producing slats for roller shutters comprises:
a profiling machine 3, suitable to form a closed hollow, box section profile from a strip of metal sheet, sliding it along a longitudinal direction of advancement X; and
a foaming machine 4, which is integrated in the profiling machine 3 and is suitable for dosing a predefined quantity of a mixture of polyol and isocyanate in the unit of time inside the hollow, box section profile, partially open P1 while it is being formed by means of an injection nozzle 40.

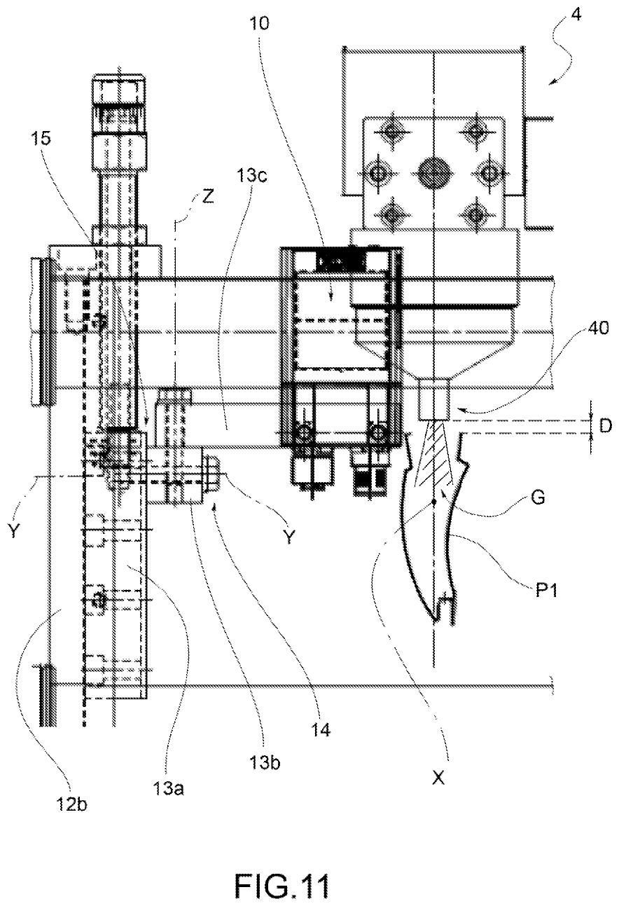

Operationally, as illustrated schematically in FIG. 11, the injection nozzle 40 generates a jet G of a mixture of polyol and isocyanate and is positionable at a predetermined dispensing position along said longitudinal direction of advancement X, above the hollow, box section profile, partially open P1 while it is being formed.

In particular, as shown schematically in FIG. 11, the injection nozzle 40 is positioned at a predetermined distance D from the hollow, box section profile, partially open P1 while it is being formed, to avoid the risk of the sliding profile impacting against the nozzle 40. Thus, the jet G is visible from the outside as it is not completely shielded by the profile.

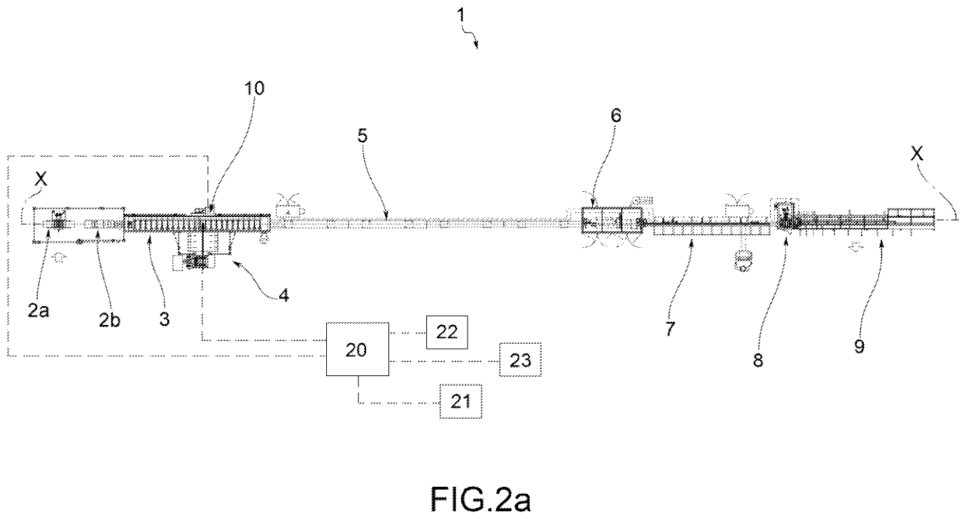

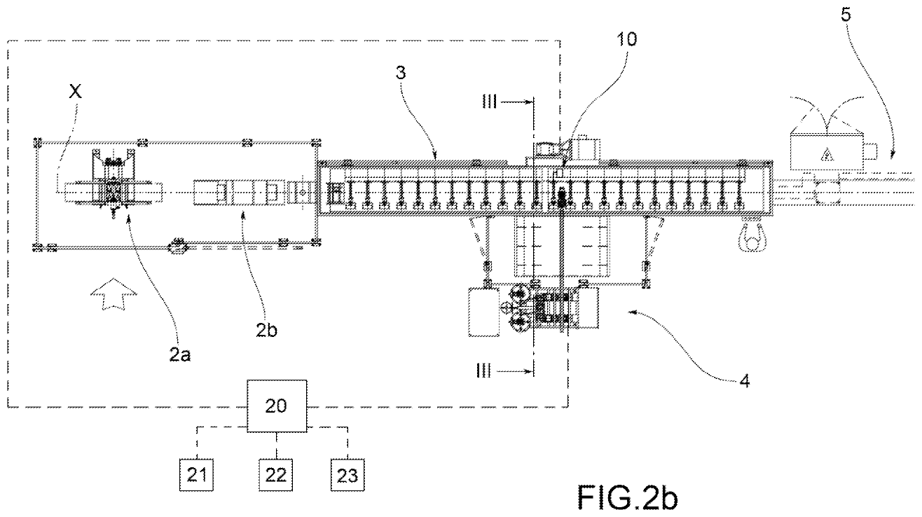

Advantageously, according to the preferred embodiment illustrated in FIG. 2a, upstream of the profiling machine 3 the slat production line 1 may comprise:
a decoiler 2a of the sheet metal that feeds the production line 1; and
a sheet metal preheating bench 2b.

Advantageously, immediately downstream of the profiling machine 3, the slat production line 1 comprises a polymerization bench 5, which is arranged to obtain a closed, hollow, foamed, box section profile.

Advantageously, downstream of the polymerization bench 5, the slat production line 1 may further comprise a cutting apparatus 6 that is suitable to cut the closed, hollow, foamed, box section profile to obtain semi-finished slats of a predetermined length.

Advantageously, downstream of the cutting apparatus 6, the slat production line 1 may further comprise:
at least one machining apparatus 8 (typically, a punching machine) for finishing the slats, which is connected to the cutting apparatus via a device for collecting and transporting the semi-finished slats; and
an unloading bench 9 for the finished slats.

According to the invention, the slat production line 1 comprises an optical acquisition device 10 that is arranged in proximity to said predefined dispensing position and is suitable to capture, preferably continuously, images of the jet G of the polyol and isocyanate mixture dispensed from said injection nozzle 40.

Also according to the invention, the slat production line 1 further comprises a control system 20, which:
is connected to the aforesaid optical acquisition device 10 to capture images of the jet G generated by the device 10; and
is configured to compare the captured images with at least one reference image of the jet G stored in memory means 21 associated with said control system 20, so as to verify whether the captured images of the jet G are comparable within predefined error margins with said reference image or whether they deviate from it.

The aforesaid reference image relates to a jet G correlated with proper foaming of the hollow, box section profile, partially open P1 while it is being formed.

The expression “jet correlated with proper foaming of the hollow, box section profile, partially open while it is being formed” means a jet having characteristics such as to ensure that the mixture of polyol and isocyanate dispensed by the injection nozzle enters the hollow, box section profile completely without being dispersed even in part to the outside.

The aforesaid control system 20 is programmed to activate an alarm procedure if a deviation from said reference image is detected.

Due to the invention, the production line 1 is subjected to continuous monitoring of the foaming stage. Said monitoring allows for real-time detection of operational situations that may result in anomalous foaming and the polyurethane foam leaking out of the hollow, box section profile.

Operationally, the activation of an alarm procedure correlated with the detection of anomalous situations may therefore allow for:
execution of operations aimed at restoring optimal foaming conditions before foam leakage situations are generated; or
a timely blocking of the plant, and in particular of the foaming machine, to minimize the extent of soiling generated by any leakage of polyurethane foam.

Thus, due to the invention, the frequency and extent of polyurethane foam leaks may be significantly reduced, thereby limiting downtime associated with cleaning operations.

Preferably, the aforesaid control system 20 is configured to compare the captured images with said at least one reference image of the jet G based on predefined geometric characteristics of said jet.

Preferably, the predefined geometric characteristics of the jet based on which the comparison with reference images is conducted comprise the direction of the jet and/or the shape of the jet. The jet G may be likened to a cone with a vertex in the injection nozzle. The direction of the jet is identifiable with the axis of the cone, while the shape of the jet may be defined by the opening angle of the cone.

In fact, it has been possible to verify that generally the leakage of polyurethane foam is due to:
a misdirection of the jet from the injection nozzle to the hollow, box section profile (e.g., due to the presence of partial obstructions of said nozzle); and/or
a jet having an excessively wide or irregular cone of flow, such that it is not confined to the inlet slot in the internal cavity defined by the partially open box body.

Therefore, the comparison based on the direction of the jet and/or the shape of said jet allows for the identification of most of the anomalies possible in the foaming stage and efficient and timely intervention to avoid or at least reduce leakages of polyurethane foam.

Preferably, the aforesaid alarm procedure comprises:
activating an audible and/or visual signalling device 22 if a deviation from said reference image having a magnitude less than a predefined safety margin is detected; or
the automatic blocking of the entire line 1, and in particular of the foaming machine 4, if a deviation from said reference image having a magnitude larger than said predefined safety margin is detected.

For this purpose, the control system 20 is connected to the audible and/or visual signalling device 22 and a general blocking device 23 of the line 1.

Preferably, activation of the audible and/or visual signalling device 22 is reserved for the occurrence of operational situations wherein the dispensed jet does not yet have characteristics that are likely to cause polyurethane foam leakage, but which are potentially likely to degenerate into foam leakage situations. In this case, the audible and/or visual signalling may allow production line operators to program a temporary blocking of the system to allow an adjustment of the nozzle to restore a regular jet.

The automatic blocking of the entire line is to be considered an emergency action determined by the occurrence of an actual polyurethane foam leakage. In this case, in order to reduce the extent of soiling and thus the subsequent cleaning and restoration of the line 1, it is essential to promptly stop the supply of polyurethane foam.

Advantageously, the control system 20 is configured to process a predefined number of images captured in the unit of time.

Preferably, the aforesaid general blocking device 23 of the line 1 is programmed to disable the foaming machine 40 in priority to other devices of the line 1.

Preferably, said optical acquisition device 10 is a camera or video camera.

Advantageously, said optical acquisition device is associated with a support structure 11. In particular, said support structure 11 may be connected to the support structure of the profiling machine 3.

Preferably, the support structure 11 of the optical acquisition device 10 comprises an orientable portion 12, 13 so that the orientation of the optical acquisition device 10 with respect to the injection nozzle 40 may be varied when arranged in the dispensing position.

Operationally, the orientation of the optical acquisition device 10 with respect to the injection nozzle 40 may be varied to allow the device 10 to better frame the jet G dispensed from the injection nozzle 40.

In particular, the support structure 11 is an articulated structure.

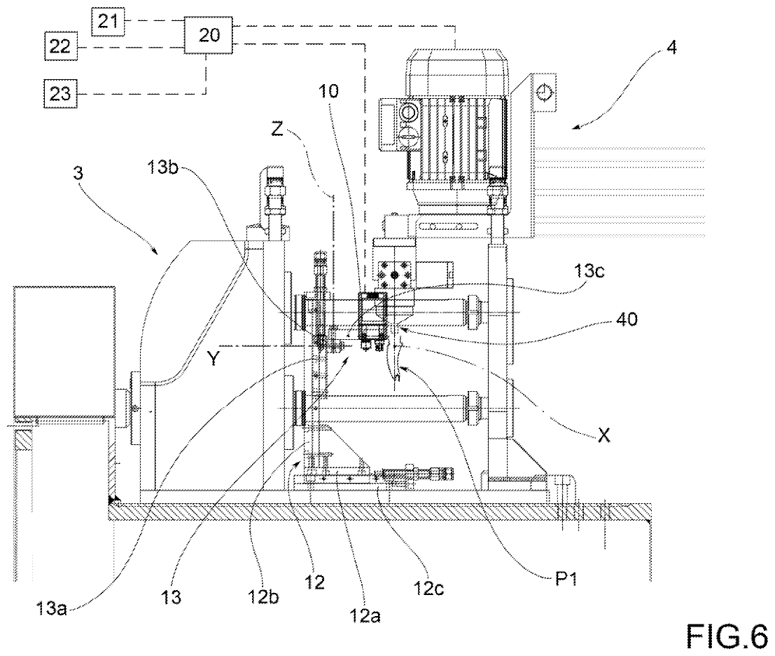

According to the preferred embodiment of the invention, illustrated in particular in FIGS. 6 to 10, the support structure 11 comprises a support bracket 12 defined by the joining of a horizontal base plate 12a and a vertical base plate 12b. The position of the support bracket 12 with respect to the injection nozzle 40 is adjustable transversely to the longitudinal direction of advancement X. For this purpose, the horizontal base plate 12a slides—transversely to the longitudinal direction of advancement X—by a fixed support base 12c which is associated with the support structure of the profiling machine 3.

The support structure 11 further comprises an articulated arm 13, at one free end 13′ of which the optical acquisition device 10 is attached.

More specifically, the articulated arm 13 comprises three segments 13a, 13b, and 13c connected together by two joints 14 and 15. The articulated arm 13 is slidingly associated in the vertical direction with the vertical plate 12b of the support bracket 12 via a first (initial) segment 13a. In turn, the second (intermediate) segment 13b is connected to the first (initial) segment 13a via a first joint 14, which defines a horizontal axis of rotation Y, transverse to the longitudinal direction of advancement X. Finally, the third segment 13c (terminal; defining the free end of the articulated arm 13) is connected to the second (intermediate) segment 13b via a second joint 15, which defines a vertical axis of rotation Z.

Operationally, the orientation of the optical acquisition device 10 may be adjusted with respect to the injection nozzle 40 by varying:
the relative position between the support bracket 12 and the fixed support base 12c; and/or
the relative position between the articulated arm 13 and the support bracket 12; and/or
the relative positions between the three segments 13a, 13b, and 13c of the articulated arm 13.

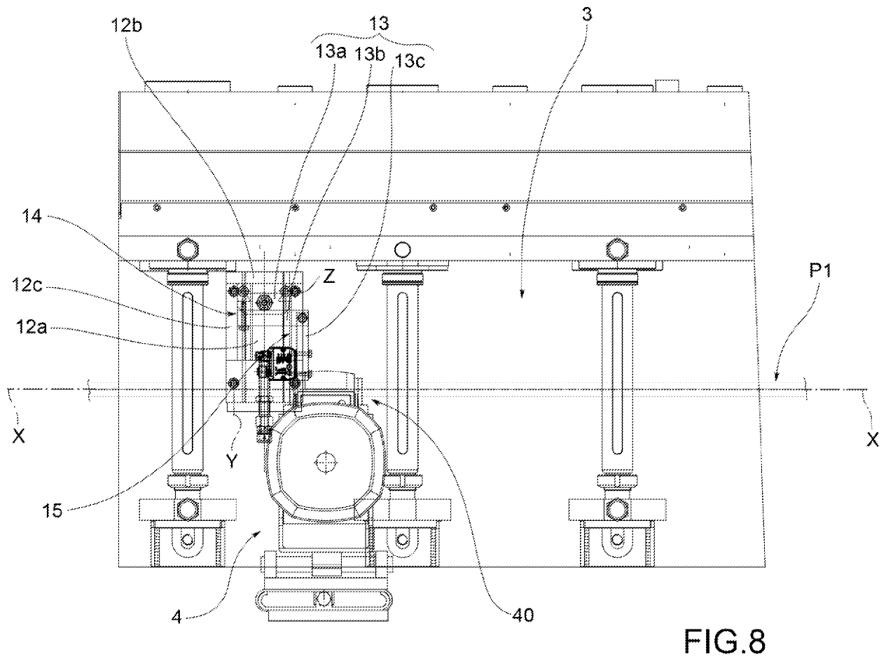

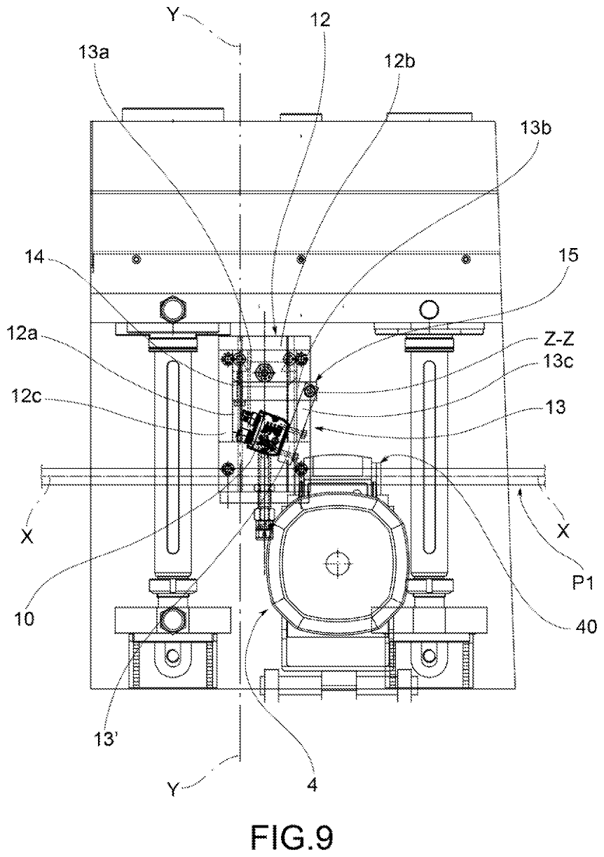

Comparing FIG. 8 with FIG. 9, it is possible to appreciate the different orientation of the device 10 with respect to the injection nozzle 40 obtained by a rotation around the axis Z allowed by the joint 15 of the articulated arm 13.

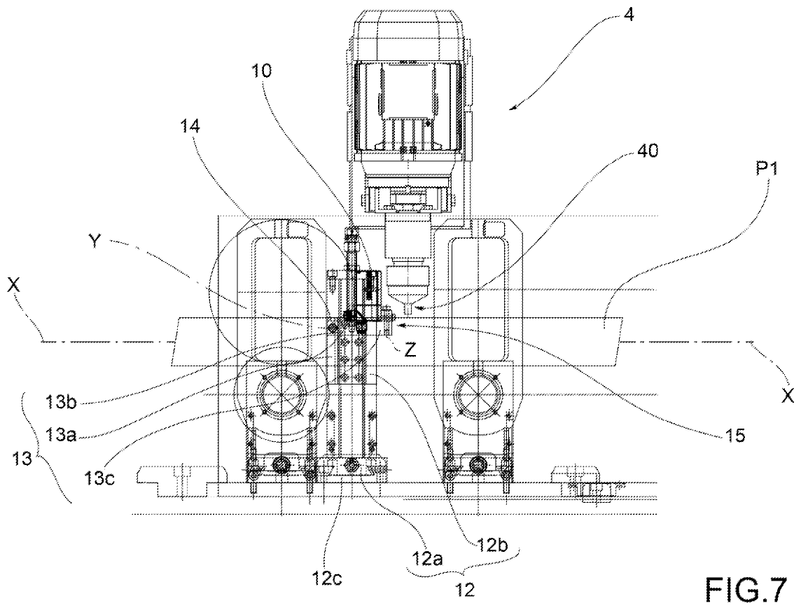

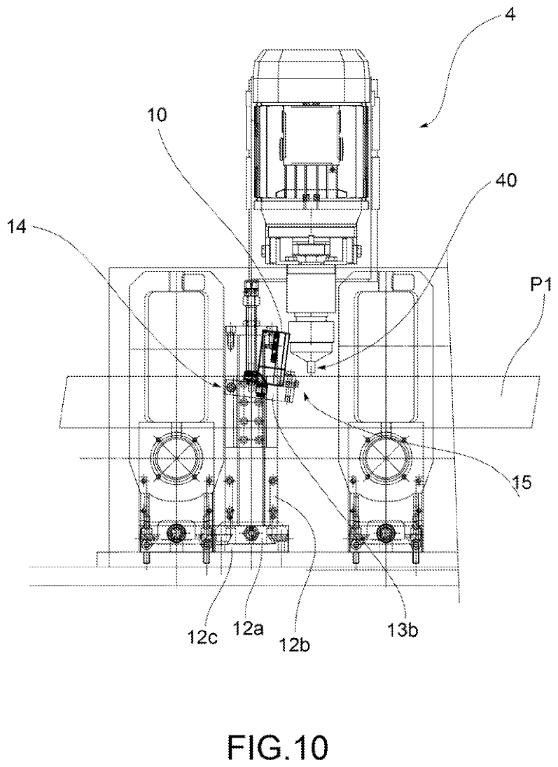

On the other hand, comparing FIG. 7 with FIG. 10, it is possible to appreciate the different orientation of the device 10 with respect to the injection nozzle 40 obtained by a rotation around the axis Y allowed by the joint 14 of the articulated arm 13.

The subject of the present invention is also to provide a method for producing slats for roller shutters.

In particular, the method according to the invention is implemented by means of a production line of slats for shutters, in particular such as the one that is the subject of the present invention and in particular as described above. For this reason, the method is described below using the same numerical references used to describe the production line 1 of slats for shutters according to the invention.

More specifically, the production method of slats for shutters comprises the following operational steps:
a) forming a closed hollow, box section profile from a strip of metal sheet by means of a profiling machine 3, sliding it along a longitudinal direction of advancement X; and
b) dosing into the hollow, box section profile, partially open P1 while it is being formed during step a) a predetermined amount of a mixture of polyol and isocyanate in the unit of time by means of a foaming machine 4, integrated into the profiling machine 3 and equipped with an injection nozzle 40 positionable at a predetermined dispensing position along said longitudinal direction of advancement X.

According to the invention, the method comprises the further operational steps of:
c) capturing, preferably continuously, images of the jet G of the polyol and isocyanate mixture dispensed from said injection nozzle 40 via an optical acquisition device 10 arranged in proximity to said predetermined dispensing position; and
d) comparing, by means of a control system 20 connected to said optical acquisition device 10, the images captured with at least one reference image of the jet G stored in memory means 21 associated with said control system 20 so as to verify whether the captured images of the jet G are comparable within predefined error margins with said reference image or whether they deviate from it.

The aforesaid reference image relates to a jet G correlated with a proper foaming of the hollow, box section profile, partially open P1 while it is being formed.

As already pointed out above, the expression “jet correlated with a proper foaming of the hollow, box section profile, partially open while it is being formed” means a jet having characteristics such as to ensure that the mixture of polyol and isocyanate dispensed by the injection nozzle enters the hollow box section profile completely without dispersing even in part to the outside.

The method further comprises the additional operational step e) of activating an alarm procedure if a deviation from said reference image is detected.

Due to the invention, the slat production is subjected to continuous monitoring of the foaming stage.

Said monitoring allows for real-time detection of operational situations that may result in anomalous foaming and the polyurethane foam leaking out of the hollow, box section profile.

Operationally, the activation of an alarm procedure correlated with the detection of anomalous situations may therefore allow for:
execution of operations aimed at restoring optimal foaming conditions before foam leakage situations occur; or
a timely shutdown of the plant, and in particular the foaming machine, to minimize the amount of soiling generated by any leakage of polyurethane foam.

Thus, due to the invention, the frequency and extent of polyurethane foam leaks may be significantly reduced, thereby limiting downtime associated with cleaning operations.

Advantageously, the aforesaid comparison step d) is performed based on predefined geometric characteristics of the jet, which preferably comprise jet direction and/or jet shape.

Preferably, the aforesaid comparison step d) is performed by processing a predefined number of images captured in the unit of time.

Preferably, the alarm procedure comprises:
the activation of an audible and/or visual signalling device 22 if a deviation from said reference image having a magnitude less than a predefined safety margin is detected; or
the automatic blocking of the entire line 1, and in particular of the foaming machine 4, if a deviation from said reference image is detected having a magnitude larger than said predefined safety margin.

Preferably, the activation of the audible and/or visual signalling device 22 is reserved to the occurrence of operational situations in which the jet dispensed does not yet have characteristics that are likely to cause leakages of polyurethane foam, but which are potentially likely to degenerate into foam leakage situations. In this case, the audible and/or visual signalling may allow production line operators to program a temporary blocking of the system to allow an adjustment of the nozzle to restore a regular jet.

The automatic blocking of the entire line is to be considered an emergency action determined by the occurrence of an actual leakage polyurethane foam. In this case, in order to reduce the extent of soiling and thus the subsequent cleaning and restoration of the line 1, it is essential to promptly stop the supply of polyurethane foam.

Advantageously, after steps a) and b), the production method comprises the following additional operational steps of:
e) allowing the polyol and isocyanate mixture to polymerize until an expanded polyurethane foam is completely formed inside the closed, hollow, box section profile, so that a foamed, closed, hollow, box section profile is obtained, and
f) cutting the foamed, closed, hollow, box section profile using a cutting apparatus 6 to obtain semi-finished slats of a predetermined length.

The advantages associated with the application of the production method according to the invention are the same as those described in relation to the production line 1 according to the invention and will not be presented again for brevity of description.

The invention achieves numerous advantages which have already been described in part.

The line and method for producing slats for roller shutters according to the invention allow the frequency and extent of leakages of polyurethane foam to be significantly reduced, thereby limiting downtime associated with cleaning operations.

The production line and method for producing slats for roller shutters according to the invention are also operationally simple to control and at the same time reliable.

The invention thus conceived therefore achieves its intended objects.

Obviously, in its practical embodiment, it may also assume forms and configurations that differ from the ones described above without departing from the present scope of protection.

Moreover, all parts may be replaced with technically equivalent ones, and the dimensions, forms, and materials employed may be of any type depending on the needs.

1. Production line of slats for roller shutters, comprising:
a profiling machine suitable to form a closed hollow, box section profile from a metal strip, making it slide along a longitudinal direction of advancement; and
a foaming machine, integrated in the profiling machine and suitable to dose inside the hollow, box section profile, partially open while it is being formed, a predetermined quantity of a mixture of polyol and isocyanate in a unit of time by means of an injection nozzle which can be positioned in a predefined dosing position along said longitudinal direction of advancement,
wherein it comprises an optical acquisition device which is arranged in proximity to said predefined dosing position and is suitable to capture, preferably continuously, images of the jet of polyol and isocyanate mixture dispensed by said injection nozzle,
and wherein it comprises a control system which is connected to said optical acquisition device to capture the images of the jet generated by said device and is configured to compare the captured images with at least one reference image of the jet stored in memory means associated with said control system so as to verify whether the captured images of the jet are comparable within predefined error margins with said reference image or whether they deviate from it, wherein said reference image is relative to a jet related to a correct foaming of the hollow, box section profile, partially open while it is being formed, said control system being programmed to activate an alarm procedure in the event in which a deviation from said reference image is detected.

2. The line according to claim 1, wherein said control system is configured to compare the captured images with said at least one jet reference image based on predefined geometric characteristics of the jet, which preferably comprise jet direction and/or jet shape.

3. The line according to claim 1, wherein said alarm procedure comprises:
activation of an audible and/or visual signalling device if a deviation from said reference image of a magnitude less than a predefined safety margin is detected; or
the automatic blocking of the entire line, and in particular of the foaming machine, if a deviation from said reference image is detected which is larger than said predefined safety margin.

4. The line according to claim 3, wherein said control system is connected to said audible and/or visual signalling device and to a device for general blocking of the line.

5. The line according to claim 4, wherein said line general blocking device is programmed to deactivate the foaming machine on a priority basis.

6. The line according to claim 1, wherein said optical acquisition device is a camera or video camera.

7. The line according to claim 1, wherein said optical acquisition device is connected to a support structure.

8. The line according to claim 7, wherein said support structure comprises an orientable portion.

9. The line according to claim 1, wherein said control system is configured to process a predefined number of images captured in the unit of time.

10. Production method of slats for roller shutters, comprising the following operating steps:
a) forming a closed, hollow, box section profile from a strip of metal sheet by means of a profiling machine, making it slide along a longitudinal direction of advancement;
b) dosing into the hollow, box section profile, partially open while it is being formed during step a), a predetermined quantity of a polyol and isocyanate mixture in a unit of time, by means of a foaming machine, integrated in the profiling machine and provided with an injection nozzle which can be positioned in a predefined dosing position along said longitudinal direction of advancement;
wherein it comprises the further operating steps of:
c) capturing, preferably continuously, images of the jet of polyol and isocyanate mixture dispensed by said injection nozzle by means of an optical acquisition device placed in proximity to said predetermined dosing position;
d) comparing by means of a control system connected to said optical acquisition device the captured images with at least one reference image of the jet stored in memory means associated with said control system so as to verify whether the captured images of the jet are comparable within predefined error margins with said reference image or whether they deviate from it, wherein said reference image is relative to a jet related to a correct foaming of the hollow, box section profile, partially open while it is being formed; and
e) activating an alarm procedure in the event in which a deviation from said reference image is detected.

11. The method according to claim 10, wherein said step d) of comparing is carried out on the basis of predefined geometric characteristics of the jet, which preferably comprise the direction of the jet and/or the shape of the jet.

12. The method according to claim 10, wherein said step d) of comparing is carried out by processing a predefined number of images captured in the unit of time.

13. The method according to claim 10, wherein said alarm procedure comprises:
activation of an audible and/or visual signalling device if a deviation from said reference image of a magnitude less than a predefined safety margin is detected; or
the automatic blocking of the entire line, and in particular of the foaming machine, if a deviation from said reference image is detected which is larger than said predefined safety margin.
